(19) United States
(12) Patent Application Publication
(10) Pub. No.: US 2013/0169420 A1
(43) Pub. Date: Jul. 4, 2013

(54) Electronic Control Glove

(71) Applicant: Willie Lee Blount, JR., Columbia, MD (US)

(72) Inventor: Willie Lee Blount, JR., Columbia, MD (US)

(73) Assignee: Blue Infusion Technologies, LLC, Columbia, MD (US)

(21) Appl. No.: 13/822,688

(22) PCT Filed: Oct. 18, 2011
(86) PCT No.: PCT/US11/56657

§ 371 Date: Mar. 13, 2013

Related U.S. Application Data
(60) Provisional application No. 61/394,013, filed on Oct. 18, 2010.
(60) Provisional application No. 61/394,879, filed on Oct. 20, 2010.

(51) Int. Cl. G08C 17/02

(52) U.S. Cl. CPC G08C 17/02
USPC 340/12.5

(57) ABSTRACT

Many people active and inactive can't readily control their audio experience without reaching into a pocket or some other location to change a setting or answer the phone. The problem is the lack of convenience and the inaccessibility when the user is riding his motorcycle, skiing, bicycling, jogging, or even walking with winter gloves on, etc. The electronic control glove described here enables enhanced control over electronic devices wirelessly at all times from the user's fingertips. The glove is manufactured with electrical conducive materials along the fingers and the thumb, where contact with the thumb and finger conductive materials creates a closed circuit which is transmitted to a control device on the glove that can then wirelessly transmit messages to remote electronic devices such as cell phones, audio players, garage door openers, military hardware and software, in work environments, and so forth.

### CROSS REFERENCE TO RELATED APPLICATIONS

This application claims priority to U.S. Provisional Application No. 61/394,013, filed Oct. 18, 2010 and to U.S. Provisional Application No. 61/394,879, filed Oct. 20, 2010

### BACKGROUND

1. Field of the Invention

This invention relates to a glove that can be used to control electronic devices and methods therefor.

2. Background of the Invention

Electronic devices and instant wireless connections to the internet, communications systems, recording systems and global positioning devices are ubiquitous in modern society. Operating such devices during activities which require two hands and line of sight with the subject activity such as sports, driving or the work environment can prove to be annoying or even dangerous. Public safety activities such as firefighting, police work or national defense activities, including the battlefield requires a user to often remove one's eyes and hands from the activity and fumble to find controls, often with devastating consequences, such as accidents and potential fatalities.

There exists a need to provide control over remote electronic devices while allowing the user to maintain visual line of sight with the person's activity and to allow the user to maintain greater hands-on control of the activity.

### SUMMARY OF THE INVENTION

The present invention generally provides an electronically capable glove which enables wireless control of devices and allows physical attachment of electronic devices for enhanced behavior and methods therefor.

### BRIEF DESCRIPTION OF THE FIGURES

FIG. 1 is a front view of an electronic control glove of the invention.

FIG. 2 is a rear view of an electronic control glove of the present invention.

FIG. 3 shows a rear view of an electronic control glove of the invention with the internal wiring shown running from the finger sensors to a position on the back of the glove.

FIG. 4 is a facing view of a view screen of a control unit for an electronic control glove in accordance with one embodiment of the present disclosure.

FIG. 5 is a bottom view of a detachable control unit for an electronic control glove in accordance with one embodiment of the present disclosure.

FIG. 6 is a view of the circuit board of the control unit for an electronic control glove of the invention, and the position of the circuit board within the case of the control unit in accordance with one embodiment of the present disclosure.

FIG. 7 depicts an electronic control glove of the invention and the position of the control unit on the back of the glove according to one embodiment of the invention.

FIG. 8A depicts the position of a control unit on the back of the glove and an example of a closure which is open for maintenance or removal, according to one embodiment of the invention.

FIG. 8B shows the control unit closure secured to protect the control unit while the electronic control glove of the invention is in use.

FIG. 9 illustrates the use of the glove wherein the thumb touches a sensor on a finger to close the circuit and activate the control unit to perform a pre-determined function.

FIG. 10 depicts the signals sent from the electronic control glove unit extending wirelessly to one or more of several target electronic devices or control functions.

FIG. 11A shows one embodiment of the connection of a detachable control unit.

FIG. 11B show an alternative embodiment of a detachable control unit attachment to a connector which would be permanently affixed to an electronic control glove.

### DETAILED DESCRIPTION OF THE INVENTION

The present invention is drawn to an electronically capable glove which enables wireless control of devices and/or allows physical attachment of electronic devices for enhanced behavior. The device of the invention can be used to control electronic devices, including, but not limited to audio and music devices, phones and any signal receiving microprocessor devices, GPS devices, household electronics like DVRs, TVs, gaming devices, control systems, such as garage door openers, security gates, lighting and the like, security systems, walkie-talkies, and the like. The glove of the invention can also be used by first responders to allow the user to maintain greater hands-on control of communication to entire units or specific individuals or devices. The glove of the invention can be also used by the military for communications and tactical control of electronic devices. Physicians or health care providers can also use the electronic control glove of the invention to allow hands-free communication with other persons or remote control of medical equipment or devices. The glove of the invention can be used by anyone to control devices which include, but are not limited to wireless phones, music players, video players, and other capable electronic devices and appliances. The device is also usable in gaming systems. Additional uses include home system controls such as TV, audio systems, video games, and toys such as remote control cars, computer programs, and environmental system controls, as well as device control by disabled persons. A waterproof version of the glove of the invention can be used in scuba diving or other water sports.

The electronic control gloves of the invention are constructed with a connector and housing for the control unit attached to the back of the glove. There are wires, conductive fabrics, or any conductive material or compound running to specific points on each finger and connected to the central control circuit. Then a person may control remote devices through signals sent to the control unit. The invention also includes an electronic control unit which includes circuitry, a power source, a signal processor/transmission device and a computer microprocessor unit, CPU, computer processing chip or the like, which is programmable with computer code to control the unit for its intended use. Optionally, the glove of the invention may have a human-readable display and include speakers and a microphone.

An alternative embodiment includes an inner liner with conductive fabrics and/or threads that can be retrofitted into other existing gloves used in sporting or other uses as stated herein.

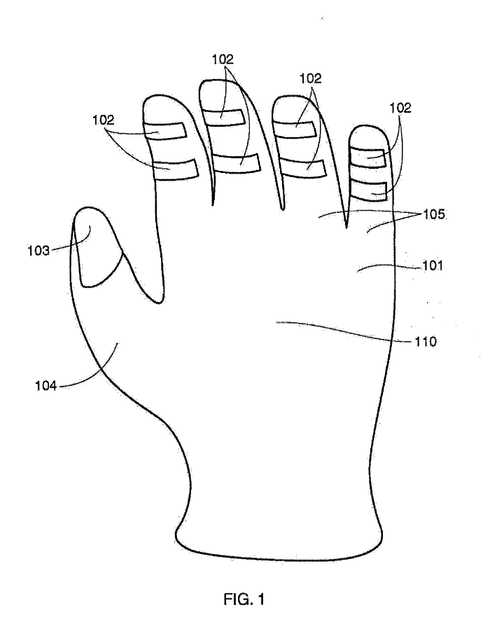

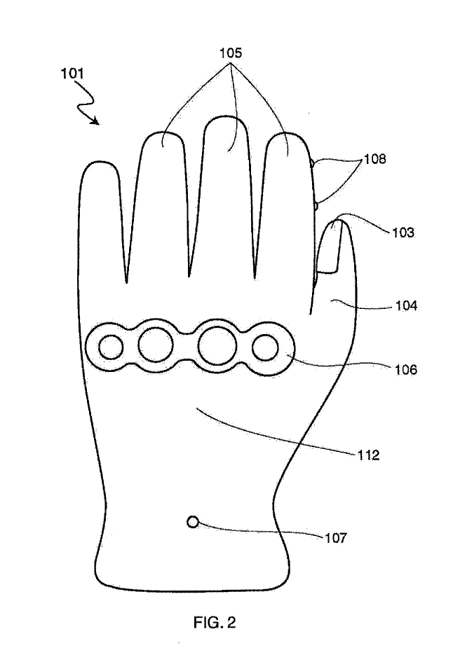

FIGS. 1 and 2 are front and rear views, respectively, of an electronic glove unit that can be used with the present invention. The glove 101 is the material that may be used to cover any part or all of the user's hand. The cloth may be made from, but not limited to leather from any animal hide usable for leather, including but not limited to cowhide, kangaroo, bison, pigskin, deer-hide, alligator, and the like; natural fibers, including wool, cotton, rayon, silk, bamboo, linen, rubber, latex and the like; and synthetic materials such as acetate, acrylic, carbon fiber, KEVLAR, neoprene, nylon, polyester, microfiber, PVC, polypropylene, polyurethane, polyurethane, nitrile, synthetic rubber, vinyl, and the like; heat resistant materials such as TEMPER-BLOC, COOL-GRIP, SILA-CHLOR or PROTEX; waterproof materials such as GORETEX and the like; or any combination thereof. The gloves may be fully lined or partially lined with any material including, but not limited to leather from any animal hide usable for leather, including but not limited to cowhide, kangaroo, bison, pigskin, deer-hide, alligator, and the like; natural fibers, including wool, cotton, rayon, silk, bamboo, linen, rubber, latex and the like; and synthetic materials such as acetate, acrylic, COOL-MAX, neoprene, nylon, polyester; microfiber, PVC, polypropylene, polyurethane, polyurethane, nitrile, synthetic rubber, vinyl; heat resistant materials; waterproof materials, such as GORETEX; and the like, or any combination thereof. Alternatively the glove can be insulated with any material including, but not limited to wool, cotton, acetate, acrylic, rayon, silk, neoprene, nylon, polyester, THINSULATE, bamboo, linen, microfiber, PVC, polypropylene, polyurethane, animal fur, and the like; or any combination thereof. Conductive pads 102 are located on several locations on each finger 105 and may be any conductive material such as thread, ink, paint, or wiring material. A thumb selector pad 103 is present on the thumb 104 of the glove 101 and when touched to the finger sensors 102 close a circuit to perform a desired function. Touching different finger sensors can produce a pre-determined different result.

A ski glove of the invention includes, but is not limited to communication to provide ski course GPS markers, trail diamond ratings, IPOD control, emergency contact communication, avalanche warnings, and the like. The materials of the glove include materials needed for protection of the wearer's hands and the control unit in cold, wet environments use by skiers. A motorcycle glove includes high impact protection and knuckle guards to protect the user and the control unit against the potential of motorcycle accidents or protection against flying roadway debris. Gloves for use in scuba or water environments are designed to protect the electrical components of the glove against water damage and also protection in high pressure environments.

FIG. 2 illustrates a back view with a user's palm facing outward of the electronic control glove in accordance with one embodiment of the present invention. An optional knuckle guard 106 is provided on the back 112 of the glove in those sports gloves where such a guard would be necessary, such as ski gloves or motorcycle gloves. Additional padding, ornamentation or other fixtures may be added as desired and still be within the scope of the invention. One or more buttons, switches or the like are provided to turn the device on/off

The device shown in FIGS. 1 and 2 includes nine (9) sensors 102 on each hand, i.e., two (2) sensors 102 for each finger 105 and one 103 for the thumb 104. However, it should be understood that the device could include two (2) sensors, three (3) sensors, four (4) sensors (at least one on each finger), eight (8) sensors, 16 sensors or a combination thereof, or additional sensors along the fingers 105 or palm 110, that have a resolution that is capable of providing a separate tactile input for each sensor, or alternatively, one or more fingers 105, may not include any sensor, providing that at least one finger have a sensor. The invention includes a selector 103 on the tip of the thumb 104 or in a location on the glove 101 or in a separate location whereby the sensors 102 may be activated by the user. Each finger conductive sensor may also be specifically definable by the user or pre-programmed by the manufacturer.

An optional light 107 or other signaling device may also be present. The glove of the invention also optionally includes a light emitting diode (LED) or other light-emitting device 107. The light-emitting device on the glove may signal that an attempt has taken place to execute a command, or otherwise identify a status of the device. The lights may be located anywhere on the glove where the user can easily view the display, such as the back of the glove 101, the thumb 104 or the palmar surface 110. Alternatively, the status of the unit may be signaled using an auditory or by vibration means.

The user may touch the thumb selector 103 to a pre-defined finger sensor 102 to close the circuit and then power may be applied to the device to perform a particular function. An on/off switch is included and an embodiment of the switch is shown at 108, but may be located anywhere on the glove or the control unit that is easily accessible to the user. The user may select from automatically detected wireless devices desired to be controlled by touching a predefined finger sensor 102 to the thumb 103. After the electronic control glove is activated, the remote device, glove, and attached control unit should perform its expected behavior. For convenience, the user may remove a detachable control unit to use as a standard glove.

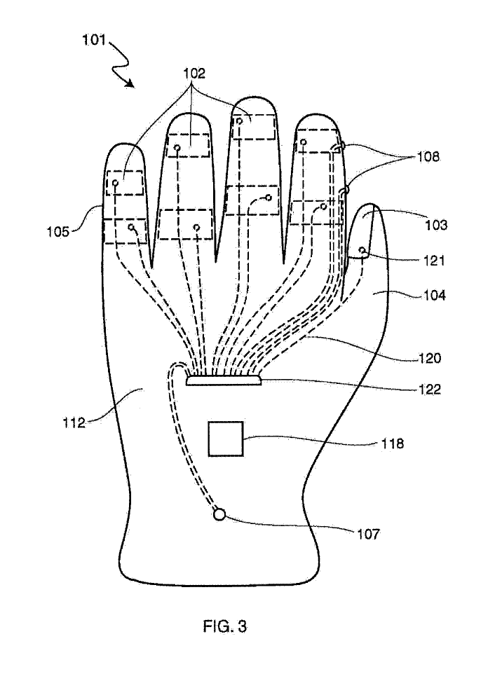

Referring now to FIG. 3, illustrated is a back view of the control glove 101 showing the location of the wires 120 embedded in the glove material out of view, which form a contact or connection 121 with the thumb selector 103 and the finger sensors 102 and lead to a harness device 122 onto which a control unit 200 can be connected to the back of the glove 112. A fastener 118 can be a VELRO-like fastening aid as shown or any other type of fastener or affixation means.

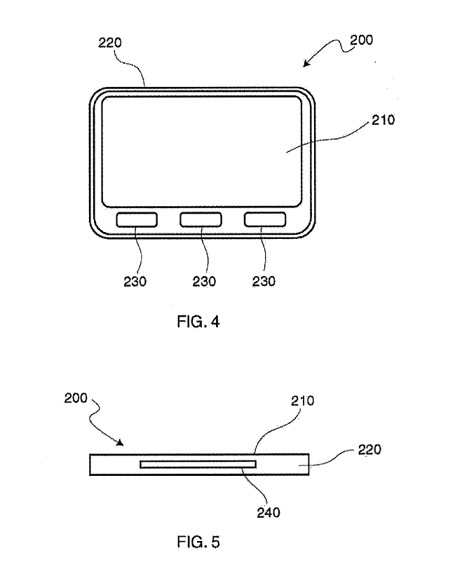

The view of FIG. 4 of the detachable control unit 200 in accordance with one embodiment of the present disclosure. The control unit 200 may have a display screen 210 that outputs information from itself and attached or unattached devices. The display may be a touch sensitive screen. The device may be enclosed in an outer casing or shell 220 made of a plastic, metal, composite, or other appropriate material. The shell 220 may be any practical size and may measure 2 inches wide×2 inches long×¼ inch deep, but may measure in any range between ½ inch long×½ inch wide×⅛ inch deep and 3½ inches long×3½ inches wide×2 inches deep, or any combination or variation thereof. Optional function buttons 230 may be used to control functions for the detachable control unit and/or the external devices controlled by the control unit. The display screen may be LED, plasma or liquid crystal display (LCD). Such screen may be a liquid crystal display (LCD), including, but not limited to, passive or active matrix LCD; thin field transistor LCD; active matrix LCD, such as blue phase, vertical alignment, advanced fringe field switching, in plane switching or twisted nematic; zero-power (bistable) LCD such as ferro liquid display, cholersteric liquid display, zenithal bistable device; or a combination thereof. The function buttons 230 each have separate functions and may be push buttons, toggle switches, and the like, for on/off, brighter screen, volume control and so forth or the same functions may be accomplished through the use of a touch screen. The screen may have a color or monochrome display.

FIG. 5 shows the control unit 200 from the bottom view and displays an embodiment of the connector portal 240 by which a connection to the glove may be accomplished. The device 200 may include a wireless interface circuit, over-the-air radio reception circuitry, speakers, microphones, light source, flash memory, buttons and physical controls, a touch sensitive screen, port for external data card access.

The device 200 may have a circuit for over-the-air digital or analog signals receipt. The device 200 may have a built in light source. The device 200 may or may not have one or more sources of sound such as speakers. The device may have one or more microphones or sound recording components. The device may optionally have flash memory, or other built-in memory locations to save files, and music. The device may have a port for interfacing with a PC or other external device. The device may have a port for external data cards such as SD cards to interface. The device may have circuitry for interfacing wirelessly with remote or local devices and/or with the electronic control glove. The device may communicate wirelessly with one or more devices through a wireless signal. The wireless connections may be established with remote devices and are controlled through the behaviors of the user through translation within the electronic control glove or through the device itself. The wireless communication may be accomplished through any known personal area network protocol such as infrared (IR) or BLUETOOTH, or through Wi-Fi, radio frequency (“RF”), a combination thereof, or the like. Alternatively, the device could have a USB or similar communication access useful for downloading additional programing or information.

Onboard circuitry may contain any or all of the necessary components to perform as intended. Proper grounding as known in the art is included in the glove and control unit circuitry. All of the contained circuitry may be connected to the display interface and produces the images necessary for human understanding of the display screen.

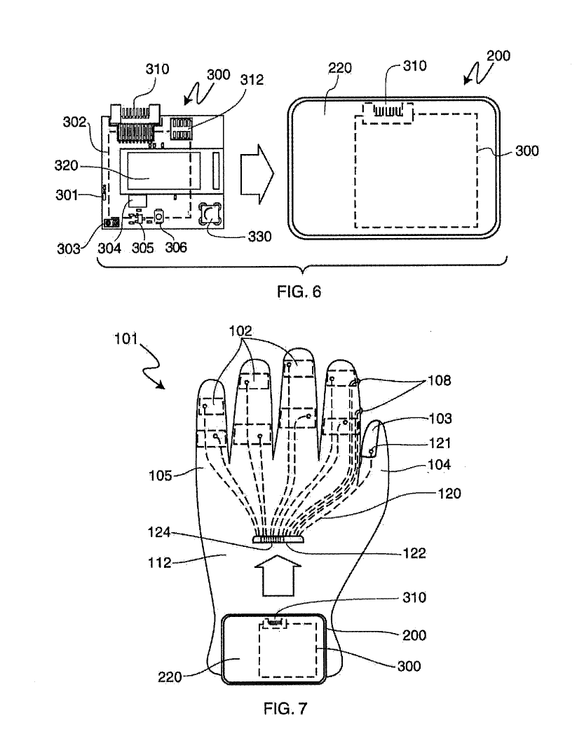

FIG. 6 displays a circuit board 300 as it is positioned into the outer casing 220 of the control unit 200. Connectors 310 are positioned so that the control unit 200 can snap into the electronic control glove at a permanent connector device 122. In detachable units, as shown in FIG. 7, the user can attach or detach the control unit 200 from the glove as desired. The circuit board comprises, but is not limited to a resistor 301, power supply 302 (behind the field of view), LED or similar alert means 303, capacitor 304, transistor 305, reset button 306, the connector 310, a microprocessor, or similar computer chip processor 312, BLUETOOTH radio device 320, and a slot for future use 330. FIG. 7 additionally illustrates the position of the control unit 200 on the back of the glove for ease of access by the user. It is understood that the position of the components can be modified, as well as functional equivalents to the listed components are included in the invention.

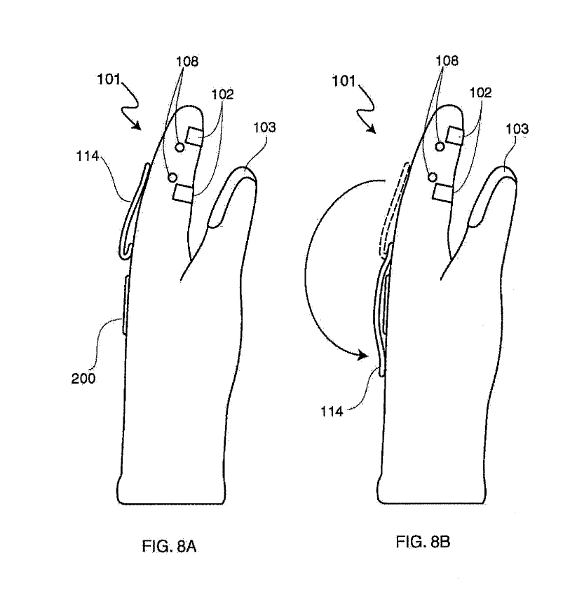

The glove and detachable control unit have connectors which join them together. The detachable control unit “snaps” into place, as shown in FIG. 7, via an electronic connection strip 124, or alternatively a control unit can be permanently affixed to the glove with protective material encasing said control unit 200. An extra cover 114 may protect glove connections when the detachable control unit is not attached as shown in FIGS. 8A (cover 114 is open) and 8B (cover 114 is closed).

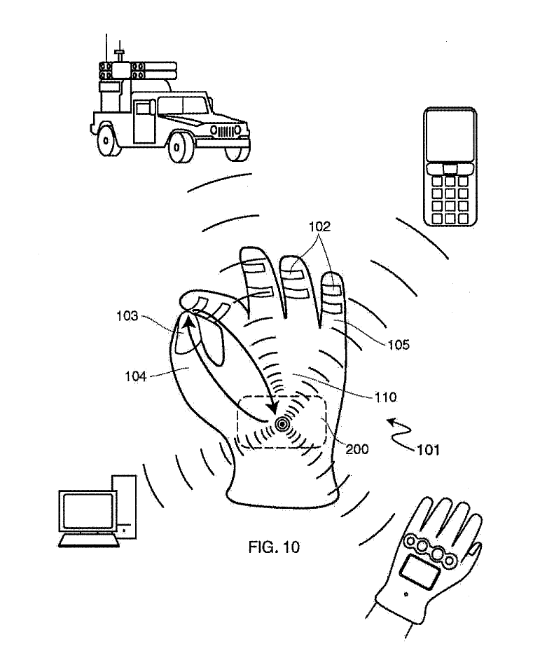

Through a wide selection of options the user has, the user can cycle through a number of wirelessly connected devices, the attached accessories and their functions giving complete control over a variety of devices as shown in FIG. 10, including, but not limited to smartphone and non-smartphone controls enabling play, pause, fast forward/rewind/next track, previous track, volume up, volume down, answer calls/reject calls/initiate calls, initiate predefined calls/voice command, GPS location tracking, audio beacon generation, light beacon generation, intercom communication, on/off, speakerphone, status identification, health monitoring, garage door control, vehicular commands, and the like. Devices with which the unit can communicate include, but is not limited to cell phone, computer, vehicles and components thereon, another electronic glove, and the like. Vibration, audio and video signals can be incorporated to alert the user.

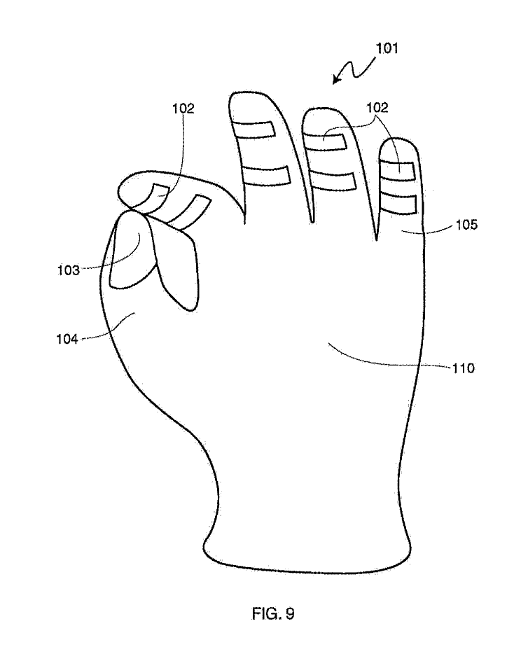

The device may be available in a variety of sizes to match a variety of hand sizes. The hand covering can be made of any material or combination of materials including, but not limited to leather, cloth, plastic, and metal, or a combination thereof. The device may contain one or more tactile, capacitive, conductive, or other sensors/buttons in one or more fingertips or elsewhere on the device. The sensors in the glove may communicate with the main circuitry. Any or all circuitry on the device may be controlled by activating one or more sensors in any combination or singularity of actions as shown in FIG. 9. Upon activation by touching the thumb to the desired finger sensor, the remote device may toggle off and on, or may be controlled by sequential selection by cycling through pre-determined selections by repeated touching of the sensor by the user's thumb.

The circuitry of the control unit may translate the signals into a wireless signal which may communicate with the wirelessly attached devices. The main circuitry may also communicate with external accessory for enhanced behavior. A ground is provided in the glove circuitry or on the control unit as known in the art.

Software would be used to take human-directed input and cause communications between two (2) or more devices to occur. Such communication between the control unit and the remote devices includes two way communications from and to the device. Such embodiments can include the receiving of external programing that would be displayed on the screen 210, or alternatively, signaled through the light device on the glove, or through auditory means.

The device may have located on it a place to securely connect an electronic accessory for enhanced performance. The device may have internal, protected circuitry to provide wireless access to remotely controllable devices. The device optionally may have an integrated radio antenna for receiving over-the-air radio broadcasts.

The device may have internal flash memory on board for storing files, music, etc. The device may have GPS capable devices built in. The device may have a built-in battery power source. The device may have a location to insert a data storage device such as an SD card.

The device may have the ability to allow a person to control and receive feedback from other devices. To make the invention, a circuit board may be built with appropriate components on board and connection to external interfaces. A shell may be created which would hold the circuit board. A display device may be attached to the shell. The device may then be programmed to behave as appropriate. The device would then be attached to an electronic control glove.

### Working Examples

### Motorcycle Control Glove

The glove of the invention includes an electronic control glove appropriate for use by motorcycle users. Said motorcycle control glove was manufactured in a manner that would protect the user and the control unit from damage from rocks and roadway debris, and also in the event of a roadway accident. The glove was made of a water resistant material and includes knuckle protection 106, such as shown in FIG. 2.

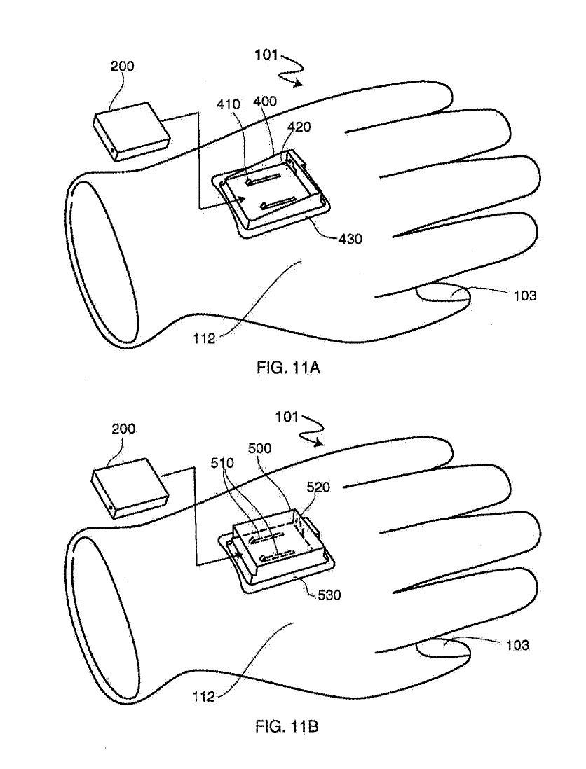

FIGS. 11A and 11B depict alternative embodiments of a connection of the control unit to the connector. FIG. 11A shows a connector open at the top wherein the control unit 200 can snap into the connector 400 by lining up the channels 410 which guide and lock the control unit to the connector housing 430. The electronic connector port 420 allows connection of the control unit to the glove electronics. FIG. 11B shows an alternative connector 500 wherein the control unit 200 can slide into by lining up the channels 510 which guide and lock the control unit into the enclosed connector unit housing 530. The electronic connector port 520 allows connection of the control unit to the glove electronics.

Having now fully described this invention, it will be understood to those of ordinary skill in the art that the same can be performed within a wide and equivalent range of conditions, formulations, and other parameters without affecting the scope of the invention or any embodiment thereof. All patents and publications, including the referenced priority documents cited herein are incorporated by reference in their entirety.

I claim:

1. An electronic control glove, comprising:
(a) a glove unit comprising finger coverings, a thumb covering which covers the tip of the thumb, and a covering over each finger of the hand; (figure in general and throughout the spec)
(b) a detachable control unit configured to wirelessly control one or more electronic devices and receive inputs from other electronic devices;
(c) a conductive thumb selector located at the tip of the thumb and operably connected to said control unit;
(d) one or more finger conductive sensors positioned along the length of the finger coverings and operably connected to the detachable control unit;
(e) one or more buttons, switches or the like to turn the device on or off;
(f) wherein the detachable control unit, thumb selector and finger conductive sensors are configured such that contacting any of the finger sensors in any combination, with the thumb selector forms a closed circuit and permits the wireless and direct control of one or more remote electronic devices, and is capable of transmitting and receiving information; and
(g) wherein each finger conductive sensor is predefined to provide wireless control over a remote electronic device when contacted by the thumb selector; and
(h) wherein the detachable control unit comprises:
(i) a protective covering configured to protect at least a part of the outer portion of the detachable control unit;
(ii) a connector capable of connecting configured to connect the detachable control unit to an electronic control garment;
(iii) control circuitry configured to directly control at least one external electronic device;
(iv) an internal flash memory;
(v) a built-in power source;
(vi) a data storage device;
(vii) a signal processor/transmission device; and
(viii) a computer microprocessor unit which is programmable with computer code to control said detachable control unit.

2. (canceled)

3. The electronic control glove of claim 1, wherein the remote electronic device is selected from the group consisting of a radio, global positioning device, phone, audio and/or music devices, video player, electronic video device, signal receiving microprocessor devices, garage door opener, security gate, security system, walkie-talkie, military tactical control device, medical equipment, environmental system control, and vehicle-mounted device control.

4. The electronic control glove of claim 1, which comprises a plurality of light devices, wherein said light devices are operably connected to said control unit such that a user can identify a status of one or more remote electronic devices.

5. The electronic control glove of claim 4, wherein said light devices are located on the electronic control glove in a position that is easily viewable by the wearer on the surface of the glove.

6. The electronic glove of claim 1 which comprises a connector such that the control unit may be detached from the glove unit, wherein said connector is permanently affixed to the glove unit and operably connected to the thumb selector and finger conductive sensors.

7. (canceled)

8. A control unit comprising:
(a) a protective covering configured to protect at least a part of the outer portion of the control unit;
(b) a connector capable of connecting the control unit to an electronic control garment;
(c) control circuitry configured to directly control at least one external electronic device;
(d) comprises an internal flash memory;
(e) a built-in power source;
(g) a data storage device;
(h) a signal processor/transmission device; and
(i) a computer microprocessor unit which is programmable with computer code to control said control unit.

9. The control unit of claim 8 wherein said electronic control garment comprises
an electronic control glove, comprising:
(a) a glove unit comprising finger coverings, a thumb covering which covers the tip of the thumb, and a covering each finger over the hand;
(b) a conductive thumb selector located at the tip of the thumb and operably connected to said control unit; and
(c) one or more finger conductive sensors positioned along the length of the finger coverings and operably connected to the control unit; and
(d) one or more buttons, switches or the like to turn the device on or off;
(e) wherein the control unit, thumb selector and finger conductive sensors are configured such that contacting any of the finger sensors in any combination with the thumb selector forms a closed circuit and permits the wireless control of one or more remote electronic devices, and is capable of transmitting and receiving information; and
(f) wherein each finger conductive sensor is predefined to provide wireless control over a remote electronic device when contacted by the thumb selector.

10. (canceled)

11. The control unit of claim 8, wherein the electronic device is selected from the group consisting of a radio, global positioning device, phone, audio and/or music devices, video player, electronic video device, signal receiving microprocessor devices, garage door opener, security gate, security system, walkie-talkie, military tactical control device, medical equipment, environmental system control, and vehicle-mounted device control.

12. The control unit of claim 8, wherein a display screen is operably attached in a manner which will allow the user to view information about remote electronic devices, the control unit and/or the electronic control glove.

13-19. (canceled)

20. The control unit of claim 8, wherein the data storage device is an SD card, a mini-SD card, a micro-SD card, and a computer chip.
